(19) United States
(12) Patent Application Publication
(10) Pub. No.: US 2026/0180216 A1
(43) Pub. Date: Jun. 25, 2026

(54) CONNECTOR DEVICE

(71) Applicant: HIROSE ELECTRIC CO., LTD., Kanagawa (JP)

(72) Inventor: Tomohiro SATO, Kanagawa (JP)

(21) Appl. No.: 19/427,502

(22) Filed: Dec. 19, 2025

(30) Foreign Application Priority Data
Dec. 25, 2024 (JP) 2024-228617

(51) Int. Cl. H01R 12/71; H01R 12/75

(52) U.S. Cl. CPC H01R 12/716; H01R 12/75

(57) ABSTRACT

Provided is a connector device including: a first connector and a second connector fittable in each other, a first housing of the first connector has an attachment portion which is configured such that a cable is attachable thereto and a protrusion which protrudes outward in a second direction crossing a first direction which is a direction of attaching the cable to the attachment portion, a second housing of the second connector has an engagement portion and a reinforcing metal fitting located on a tip end side in the first direction with respect to the engagement portion, the engagement portion includes an inclined surface with a downward slope toward the reinforcing metal fitting, and is configured such that the protrusion is engageable therewith in a direction perpendicular to the second direction, a mounting portion of the reinforcing metal fitting includes a portion overlapping with the protrusion in the second direction.

### CROSS-REFERENCE TO RELATED APPLICATION

This application claims priority from Japanese Patent Application No. 2024-228617 filed with the Japan Patent Office on Dec. 25, 2024, the entire content of which is hereby incorporated by reference.

### BACKGROUND

### 1. Technical Field

The present disclosure relates to a connector device.

### 2. Related Art

There has been known a connector device for electrically connecting a cable and a circuit board. For example, in a connector device described in JP-A-2019-197685, a cable support is reinforced by a metal inner shell member. With this configuration, the cable connector device can be reduced in height, and a plurality of cables can be supported by the cable support.

### SUMMARY

A connector device according to an embodiment of the present disclosure includes: a first connector and a second connector fittable in each other, in which the first connector includes a first housing, the first housing has an attachment portion and a protrusion, the attachment portion is configured such that a cable is attachable thereto, the protrusion protrudes outward in a second direction crossing a first direction which is a direction of attaching the cable to the attachment portion, the second connector has a second housing, the second housing has an engagement portion and a reinforcing metal fitting located on a tip end side in the first direction with respect to the engagement portion, the engagement portion includes an inclined surface with a downward slope toward the reinforcing metal fitting, and is configured such that the protrusion is engageable therewith in a direction perpendicular to the second direction, the reinforcing metal fitting has a mounting portion to be mounted on a circuit board, and the mounting portion includes a portion overlapping with the protrusion in the second direction.

### BRIEF DESCRIPTION OF THE DRAWINGS

FIG. 1 is a perspective view of a connector device according to an embodiment;

FIG. 2 is a perspective view of a cable connector;

FIG. 3 is a side view of the cable connector;

FIG. 4 is a perspective view of a board connector;

FIG. 5 is a perspective view of the board connector;

FIG. 6 is a plan view of the board connector;

FIG. 7 is a sectional view taken along VII-VII line in FIG. 6;

FIG. 8 is a sectional view taken along VIII-VIII line in FIG. 6;

FIG. 9 is a sectional view taken along IX-IX line in FIG. 8;

FIG. 10 is a plan view of the connector device;

FIG. 11 is a sectional view taken along XI-XI line in FIG. 10;

FIG. 12 is a view showing the course of fitting the connector device from the state shown in FIG. 11;

FIG. 13 is a sectional view taken along XIII-XIII line in FIG. 10;

FIG. 14 is a view showing the course of fitting the connector device from the state shown in FIG. 13; and

FIG. 15 is a view for describing the features of the connector device.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, in the connector device described in JP-A-2019-197685, the connector device may be damaged due to force applied from the outside, for example, when the cable is pulled.

The present disclosure has been made in view of such a situation, and one object thereof is to provide a connector device of which the resistance against force applied from the outside can be enhanced.

(1) A connector device according to the present disclosure includes: a first connector and a second connector fittable in each other, in which the first connector includes a first housing, the first housing has an attachment portion and a protrusion, the attachment portion is configured such that a cable is attachable thereto, the protrusion protrudes outward in a second direction crossing a first direction which is a direction of attaching the cable to the attachment portion, the second connector has a second housing, the second housing has an engagement portion and a reinforcing metal fitting located on a tip end side in the first direction with respect to the engagement portion, the engagement portion includes an inclined surface with a downward slope toward the reinforcing metal fitting, and is configured such that the protrusion is engageable therewith in a direction perpendicular to the second direction, the reinforcing metal fitting has a mounting portion to be mounted on a circuit board, and the mounting portion includes a portion overlapping with the protrusion in the second direction.

According to the configuration of (1), in a state of the first connector and the second connector being fitted in each other, when the cable is pulled from the attachment portion of the first connector, stress is applied along the direction of attaching the cable to the engagement portion of the second connector from the protrusion of the first connector. In this case, the mounting portion of the second connector receives the stress applied from the protrusion of the first connector at a portion disposed at a position at which the protrusion of the first connector and the reinforcing metal fitting of the second connector overlap with each other in the direction crossing the direction of attaching the cable. With this configuration, the resistance of the connector device against the stress applied from the outside can be enhanced.

(2) In the connector device according to (1), it is preferred that the second housing has a buffer portion interposed between the engagement portion and the reinforcing metal fitting.

According to the configuration of (2), the stress applied to the engagement portion of the second connector from the protrusion of the first connector is reduced by the buffer portion of the second housing. With this configuration, the resistance of the connector device against the stress applied from the outside can be further enhanced.

(3) In the connector device according to (2), it is preferred that the reinforcing metal fitting and the second housing are formed by insert molding.

According to the configuration of (3), the reinforcing metal fitting and the second housing closely contact each other with no gap therebetween, and therefore, the stress applied to the engagement portion of the second connector from the protrusion of the first connector is suitably reduced by the buffer portion of the second housing. With this configuration, the resistance of the connector device against the stress applied from the outside can be further enhanced.

(4) In the connector device according to any one of (1) to (3), it is preferred that the reinforcing metal fitting includes a portion bent or curved in a raised shape in a direction orthogonal to the inclined surface of the engagement portion and a direction from the engagement portion toward the reinforcing metal fitting.

According to the configuration of (4), the stiffness of the reinforcing metal fitting against the stress applied to the engagement portion of the second connector from the protrusion of the first connector is enhanced. With this configuration, the resistance of the connector device against the stress applied from the outside can be further enhanced.

(5) In the connector device according to any one of (1) to (4), it is preferred that the reinforcing metal fitting includes a portion overlapping with the engagement portion in the first direction.

According to the configuration of (5), the stress applied to the engagement portion of the second connector from the protrusion of the first connector is received by the reinforcing metal fitting. With this configuration, the resistance of the connector device against the stress applied from the outside can be further enhanced.

(6) In the connector device according to any one of (1) to (5), it is preferred that the protrusion includes a first portion and a second portion, the first portion of the protrusion linearly extends in a third direction perpendicular to both the first direction and the second direction from an upper surface toward a lower surface of the first housing, the second portion of the protrusion includes an inclined surface with a downward slope from a lower end of the first portion of the protrusion toward the attachment portion.

(7) In the connector device according to any one of (1) to (6), it is preferred that a recess having an opening is provided on an upper surface of the second housing, and the reinforcing metal fitting is exposed through the opening.

(8) In the connector device according to any one of (1) to (7), it is preferred that the protrusion is configured to be engageable with the engagement portion in a circumferential direction centered on the second direction.

(9) In the connector device according to any one of (1) to (8), it is preferred that the second housing includes an insertion portion that penetrates the second housing in a third direction perpendicular to both the first direction and the second direction and is configured such that the protrusion is insertable thereinto, the insertion portion is formed in a step and includes a first portion, a second portion, and a third portion, the first portion of the insertion portion linearly extends in the third direction from an upper surface toward a lower surface of the second housing, the second portion of the insertion portion extends linearly and diagonally with respect to the third direction from a lower end of the first portion toward the reinforcing metal fitting, and the third portion of the insertion portion linearly extends in the third direction from a lower end of the second portion toward the lower surface of the second housing.

According to the present disclosure, the resistance against the force applied from the outside can be enhanced.

Hereinafter, one embodiment of a connector device of the present disclosure will be described with reference to the drawings. Note that hereinafter, for the sake of understanding of the description of the specification, the longitudinal direction (depth direction) of the connector device may be described as an X-axis direction, the lateral direction (width direction) of the connector device may be described as a Y-axis direction, and the height direction (thickness direction) of the connector device may be described as a Z-axis direction.

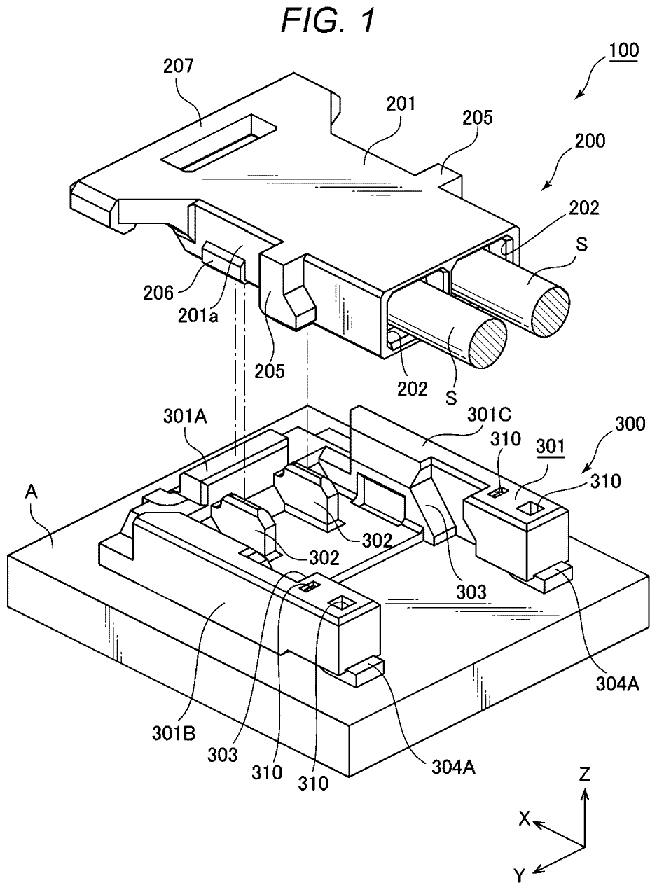

As shown in FIG. 1, a connector device 100 of the present embodiment includes a cable connector 200 as one example of a first connector, and a board connector 300 as one example of a second connector fittable in the cable connector 200.

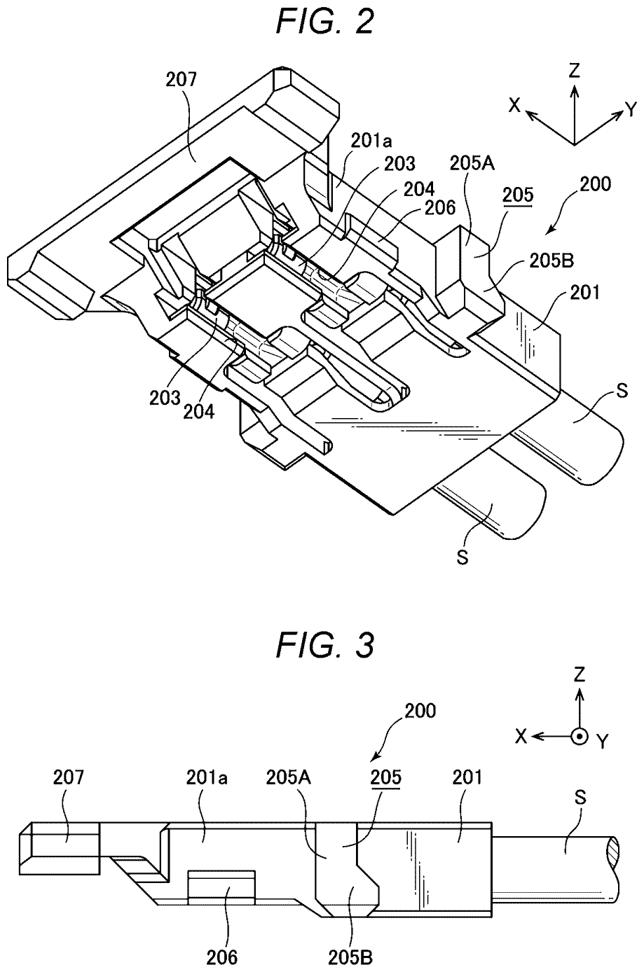

As shown in FIGS. 1 to 3, the cable connector 200 has a housing 201 as one example of a first housing extending long in the X-axis direction and formed in a hollow substantially-rectangular box shape, an attachment portion 202 provided in one end surface of the housing 201 in the longitudinal direction thereof, and a terminal 203 which is housed in the attachment portion 202 and to which one end of a cable S is electrically connected. The attachment portion 202 includes attachment portions 202 provided corresponding to the number of cables S connected to the cable connector 200, provided in parallel in one direction, and configured such that the cables S are attachable thereto in the X-axis direction. FIGS. 1 to 3 show an example where two cables S are attached to the cable connector 200, but one cable S or three or more cables S may be attached to the cable connector 200.

The surface of the housing 201 facing the board connector 300 in the Z-axis direction is provided with a slit-shaped terminal insertion portion 204. The terminal insertion portion 204 includes a pair of terminal insertion portions 204 extending in the X-axis direction in the housing 201 and provided with a gap therebetween in the Y-axis direction. The pair of terminal insertion portions 204 is disposed at positions symmetrical in the Y-axis direction with respect to the center position of the housing 201 in the Y-axis direction. The terminal insertion portion 204 penetrates a lower wall portion of the housing 201 in the Z-axis direction, and communicates with the attachment portion 202 through a space extending in the X-axis direction in the housing 201. In the course of fitting the cable connector 200 and the board connector 300 in each other, a terminal 302 of the board connector 300 to be described later is inserted into the terminal insertion portion 204 of the housing 201 of the cable connector 200, and is electrically connected to the terminal 203 of the cable connector 200.

Both side surfaces 201a of the housing 201 in the Y-axis direction are provided with protrusions 205 protruding outward in the Y-axis direction. Each of the pair of protrusions 205 has a first portion 205A and a second portion 205B. The first portion 205A is formed in a rectangular shape in side view, and linearly extends in the Z-axis direction from the upper surface toward the lower surface of the housing 201. The second portion 205B is formed in a substantially trapezoidal shape in side view, and extends in the X-axis direction and the Z-axis direction from the lower end of the first portion 205A toward the lower surface of the housing 201. Specifically, the second portion 205B extends in a tapered shape in the Z-axis direction while gradually expanding in the X-axis direction from the lower end of the first portion 205A in the Z-axis direction toward the attachment portion 202. That is, the second portion 205B has an inclined surface with a downward slope from the lower end of the first portion 205A toward the attachment portion 202.

The side surface of the first portion 205A and the tip end surface of the second portion 205B are flush with each other. The amount of protrusion from the side surface 201a of the housing 201 in the Y-axis direction is the same between the first portion 205A and the second portion 205B. The second portion 205B of the protrusion 205 is fittable in an engagement portion 306 of the board connector 300 to be described later.

Both side surfaces 201a of the housing 201 in the Y-axis direction are provided with locking claws 206 protruding outward in the Y-axis direction. The locking claw 206 is located at the center of the side surface 201a in the X-axis direction. When the cable connector 200 and the board connector 300 are fitted in each other, tip end portions of the pair of locking claws 206 are locked to part of the board connector 300, and in this manner, the pair of locking claws 206 locks a state of the cable connector 200 and the board connector 300 being fitted in each other.

An end portion of the housing 201 in the X-axis direction is provided with an operation portion 207. A user lifts up the operation portion 207 to bring the cable connector 200 into an inclined posture in the X-axis direction, and in this manner, the locking claws 206 are unlocked from the board connector 300, and the state of the cable connector 200 and the board connector 300 being fitted in each other is unlocked.

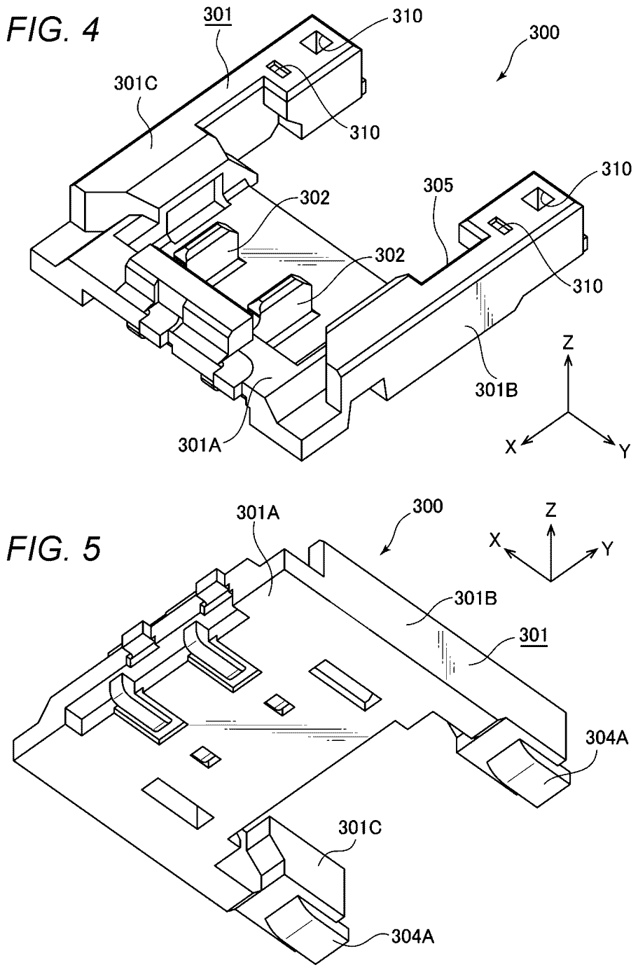

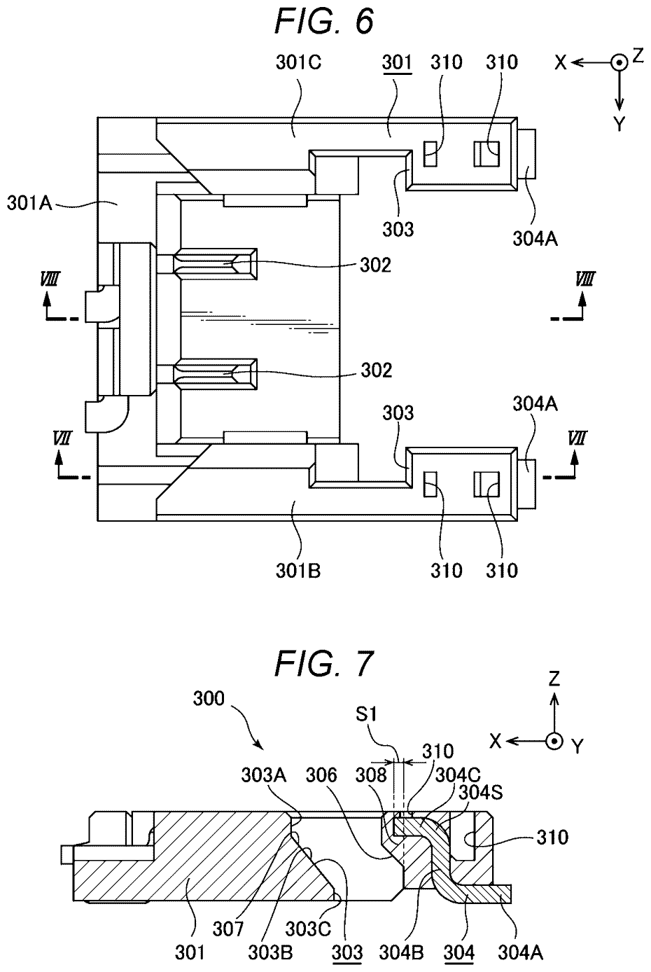

As shown in FIGS. 4 to 6, the board connector 300 is a connecter mounted on a circuit board A (see FIG. 1). The board connector 300 has a housing 301 as one example of a second housing. The housing 301 is formed in a substantially U-shape in plan view in the Z-axis direction. The housing 301 includes a first side wall portion 301A, a second side wall portion 301B, and a third side wall portion 301C. The first side wall portion 301A is located at the center of the housing 301 in the Y-axis direction. The second side wall portion 301B and the third side wall portion 301C are located on both sides of the housing 301 in the Y-axis direction. The first side wall portion 301A is provided with the terminal 302.

Each of the second side wall portion 301B and the third side wall portion 301C is provided with an insertion portion 303 and a reinforcing metal fitting 304. The protrusion 205 of the cable connector 200 is inserted into the insertion portion 303.

Each of the second side wall portion 301B and the third side wall portion 301C is connected, at the base end thereof, to the first side wall portion 301A, and extends in the X-axis direction. The reinforcing metal fitting 304 is provided at the tip end of each of the second side wall portion 301B and the third side wall portion 301C.

The surface of the housing 301 facing the cable connector 200 in the Z-axis direction is provided with a recess 305 in which the housing 201 of the cable connector 200 is housed.

As shown in FIG. 7, the insertion portion 303 of each of the second side wall portion 301B and the third side wall portion 301C is provided at a position corresponding to the protrusion 205 of the cable connector 200 in the X-axis direction. The insertion portion 303 is configured such that when the cable connector 200 and the board connector 300 are fitted in each other, the protrusion 205 of the cable connector 200 is insertable thereinto. The insertion portion 303 penetrates the housing 301 in the Z-axis direction.

The insertion portion 303 is formed in a step shape, and includes a first portion 303A, a second portion 303B, and a third portion 303C. The first portion 303A linearly extends in the Z-axis direction from the upper surface toward the lower surface of each of the second side wall portion 301B and the third side wall portion 301C (from the upper surface toward the lower surface of the housing 301). The second portion 303B extends linearly and diagonally with respect to the Z-axis direction from the lower end of the first portion 303A toward the tip end of each of the second side wall portion 301B and the third side wall portion 301C (from the lower end of the first portion 303A toward the reinforcing metal fitting 304). The third portion 303C linearly extends in the Z-axis direction from the lower end of the second portion 303B toward the lower surface of the housing 301. The third portion 303C is opened in the lower surface of each of the second side wall portion 301B and the third side wall portion 301C.

The tip-end-side end surface of the second portion 303B of each of the second side wall portion 301B and the third side wall portion 301C is an inclined surface with a downward slope toward the tip end of each of the second side wall portion 301B and the third side wall portion 301C. This inclined surface functions as the engagement portion 306 in which the protrusion 205 of the cable connector 200 is to be engaged in a direction (X-axis direction and Z-axis direction) perpendicular to the Y-axis direction.

The reinforcing metal fitting 304 is located on the tip end side in the X-axis direction with respect to the engagement portion 306 which is the tip-end-side end surface of the second portion 303B. The engagement portion 306 has an inclined surface with a downward slope toward the reinforcing metal fitting 304 (the tip end side in the X-axis direction). The engagement portion 306 may include such an inclined surface as part of the engagement portion 306.

The base-end-side end surface of the second portion 303B of each of the second side wall portion 301B and the third side wall portion 301C is an inclined surface with a downward slope toward the tip end of each of the second side wall portion 301B and the third side wall portion 301C. This inclined surface functions as a guide surface 307 that guides, when the cable connector 200 and the board connector 300 are fitted in each other, the protrusion 205 of the cable connector 200 to slide toward the tip end of each of the second side wall portion 301B and the third side wall portion 301C and positions the cable connector 200 and the board connector 300 while the cable connector 200 and the board connector 300 are moving relative to each other in the X-axis direction.

The reinforcing metal fitting 304 is formed in such a manner that a metal plate is bent, and has a predetermined width dimension in the Y-axis direction. The reinforcing metal fitting 304 is formed in a crank shape in side view in the Y-axis direction, and includes a first portion 304A linearly extending in the X-axis direction, a second portion 304B linearly extending in the Z-axis direction from the first portion 304A, and a third portion 304C linearly extending in the X-axis direction from the second portion 304B.

The first portion 304A of the reinforcing metal fitting 304 is exposed through the housing 301, and the lower surface thereof is flush with the lower surface of the housing 301. Thus, the first portion 304A of the reinforcing metal fitting 304 functions as a mounting portion mounted on the circuit board A in a state of the board connector 300 being mounted on the circuit board A.

The reinforcing metal fitting 304 includes a boundary portion between the second portion 304B and the third portion 304C as a portion 304S bent in a raised portion in a direction orthogonal to the inclined surface of the engagement portion 306 and a direction from the engagement portion 306 toward the reinforcing metal fitting 304. The reinforcing metal fitting 304 may include the boundary portion between the second portion 304B and the third portion 304C as a portion curved in a raised portion in the direction orthogonal to the inclined surface of the engagement portion 306 and the direction from the engagement portion 306 toward the reinforcing metal fitting 304. With this configuration, the stiffness of the reinforcing metal fitting 304 against stress which acts on the engagement portion 306 from the protrusion 205 in a state of the protrusion 205 of the cable connector 200 being engaged with the engagement portion 306 of the board connector 300 can be enhanced.

The reinforcing metal fitting 304 is insert-molded into the housing 301 together with the terminal 302, and closely contacts the housing 301 with no gap therebetween. Thus, the housing 301 has a buffer portion 308 interposed between the engagement portion 306 of the board connector 300 and the third portion 304C of the reinforcing metal fitting 304. The buffer portion 308 plays a role in reducing transmission of the stress, which acts on the engagement portion 306 from the protrusion 205 in the state of the protrusion 205 of the cable connector 200 being engaged with the engagement portion 306 of the board connector 300, to the reinforcing metal fitting 304.

The third portion 304C of the reinforcing metal fitting 304 includes a portion S1 overlapping with the engagement portion 306 of the board connector 300 in the X-axis direction. At least part of the portion S1 overlapping with the engagement portion 306 of the board connector 300 in the X-axis direction overlaps with the engagement portion 306 in the direction orthogonal to the inclined surface of the engagement portion 306. With this configuration, the third portion 304C of the reinforcing metal fitting 304 is easily located on a path on which the above-described stress acting on the engagement portion 306 from the protrusion 205 is transmitted, and the function of reducing transmission of such stress to the reinforcing metal fitting 304 is suitably fulfilled.

Note that in the present embodiment, the example where the buffer portion 308 is formed as part of the housing 301 has been described, but instead of or in addition to this configuration, the buffer portion 308 may be separated from the housing 301, and for example, may be made of an elastic material or the like.

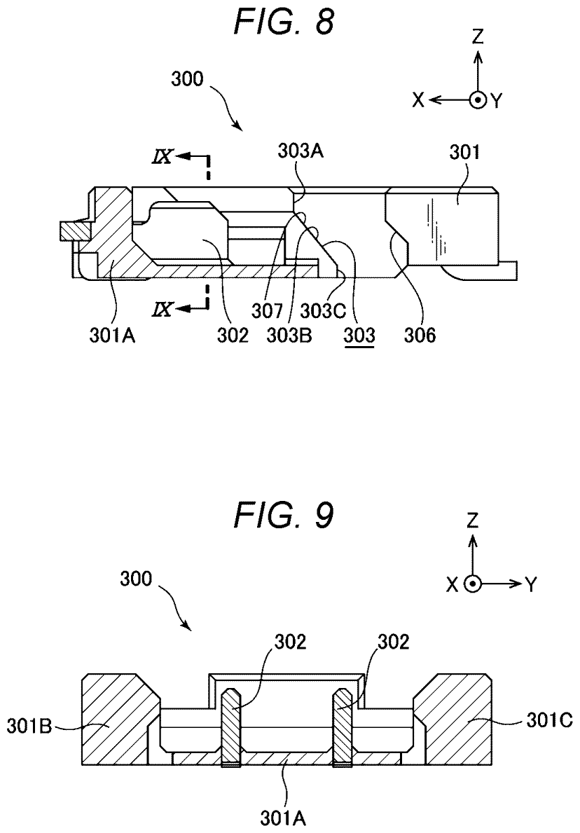

As shown in FIGS. 8 and 9, the first side wall portion 301A of the housing 301 has a substantially L-shaped section. The upper surface of the first side wall portion 301A contacts the housing 201 of the cable connector 200 when the cable connector 200 and the board connector 300 are fitted in each other, and positions the cable connector 200 and the board connector 300 in the Y-axis direction. The terminal 302 includes terminals 302 held by the first side wall portion 301A and protruding in the Z-axis direction from two positions with a gap therebetween in the Y-axis direction. By insert molding, the terminal 302 is molded integrally with the housing 301 together with the reinforcing metal fitting 304.

Each of the upper surfaces of the second side wall portion 301B and third side wall portion 301C of the housing 301 is provided with two recesses 310. An opening is formed on the far side in each of the two recesses 310, and the reinforcing metal fitting 304 is exposed to the outside of the housing 301 through this opening. In this embodiment, the reinforcing metal fitting 304 is partially exposed through the opening in each of the recesses 310.

Each recess 310 is a portion into which a rod-shaped tool (not shown) for supporting and positioning the reinforcing metal fitting 304 on the housing 301 is inserted when the reinforcing metal fitting 304 and the housing 301 are insert-molded. Each recess 310 is formed as a space after the tool has been detached from the housing 301 after insert molding.

Next, operation of the connector device 100 of the present embodiment will be described focusing particularly on operation when the cable connector 200 and the board connector 300 are fitted in each other.

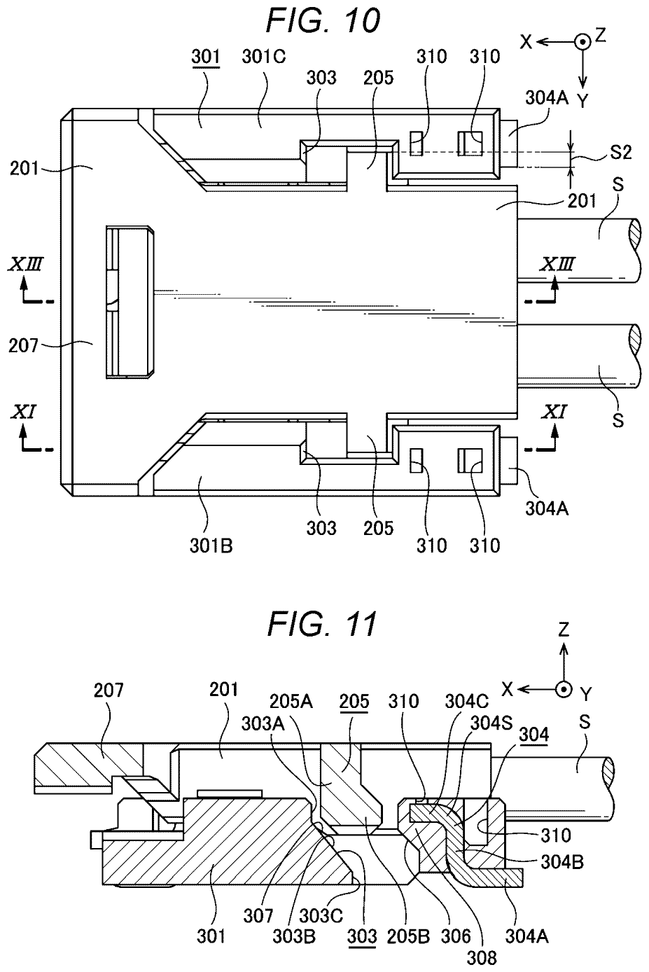

As shown in FIG. 10, in a state after the cable connector 200 and the board connector 300 have been fitted in each other, the protrusion 205 of the cable connector 200 is inserted into the insertion portion 303 of the board connector 300, and the cable connector 200 and the board connector 300 are positioned in the X-axis direction.

The first portion 304A of the reinforcing metal fitting 304 of the board connector 300 includes a portion S2 overlapping with the protrusion 205 of the cable connector 200 in the Y-axis direction. In this case, the first portion 304A of the reinforcing metal fitting 304 of the board connector 300 may overlap with the entirety of the protrusion 205 of the cable connector 200 in the Y-axis direction, or may partially overlap with the protrusion 205 of the cable connector 200 in the Y-axis direction. In this case, the first portion 304A of the reinforcing metal fitting 304 of the board connector 300 is only required to include at least a portion overlapping with the engagement portion 306 of the board connector 300 in the Y-axis direction.

The reinforcing metal fitting 304 of the board connector 300 does not necessarily have a constant dimension in the Y-axis direction. The reinforcing metal fitting 304 may include a wide portion and a narrow portion in terms of the dimension in the Y-axis direction. In this case, at least the first portion 304A of the reinforcing metal fitting 304 of the board connector 300 mounted on the circuit board A is only required to overlap with the protrusion 205 of the cable connector 200 in the Y-axis direction.

In a case where part of the first portion 304A of the reinforcing metal fitting 304 of the board connector 300 is mounted on the circuit board A, at least a portion of the first portion 304A of the reinforcing metal fitting 304 of the board connector 300 mounted on the circuit board A is only required to overlap with the protrusion 205 of the cable connector 200 in the Y-axis direction. The protrusion 205 of the cable connector 200 may extend in a direction diagonally crossing the Y-axis direction. Also in this case, the first portion 304A of the reinforcing metal fitting 304 of the board connector 300 is only required to include a portion overlapping with the protrusion 205 of the cable connector 200 in the Y-axis direction.

As shown in FIG. 11, when the cable connector 200 and the board connector 300 are fitted in each other, the protrusion 205 of the cable connector 200 faces the inner surface of the insertion portion 303 of the board connector 300 in the Z-axis direction.

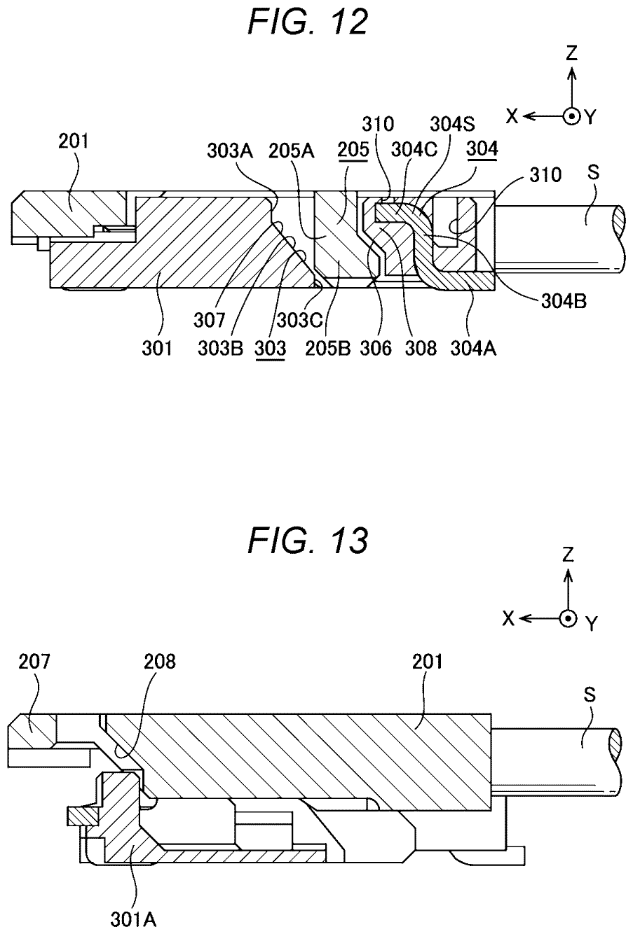

As shown in FIG. 12, when the cable connector 200 approaches the board connector 300 in the Z-axis direction, the protrusion 205 of the cable connector 200 contacts the guide surface 307 of the insertion portion 303 of the board connector 300. Then, when the cable connector 200 further approaches the board connector 300 in the Z-axis direction, the protrusion 205 of the cable connector 200 slides on the guide surface 307 of the board connector 300 toward the tip end of each of the second side wall portion 301B and third side wall portion 301C of the board connector 300. In this case, the cable connector 200 is positioned in the Y-axis direction while moving relative to the board connector 300 in the Y-axis direction, and the cable connector 200 and the board connector 300 are fitted in each other. Note that in the state of the cable connector 200 and the board connector 300 being fitted in each other, there is a gap between the protrusion 205 of the cable connector 200 and the engagement portion 306 of the board connector 300. In this embodiment, in the state of the cable connector 200 and the board connector 300 being fitted in each other, the inclined surface (tip-end-side end surface of the second portion 303B of the insertion portion 303) forming the engagement portion 306 and the inclined surface of the second portion 205B of the protrusion 205 face each other, and there is a gap with a predetermined width between these inclined surfaces. There may also be a gap with a predetermined width between the tip-end-side end surface of the first portion 303A of the insertion portion 303 and the first portion 205A of the protrusion 205. There may also be a gap with a predetermined width between the tip-end-side end surface of the third portion 303C of the insertion portion 303 and a portion of the second portion 205B of the protrusion 205 facing such an end surface.

As shown in FIG. 13, when the cable connector 200 and the board connector 300 are fitted in each other, the upper surface of the first side wall portion 301A of the board connector 300 faces a guide portion 208 of the cable connector 200 in the Z-axis direction.

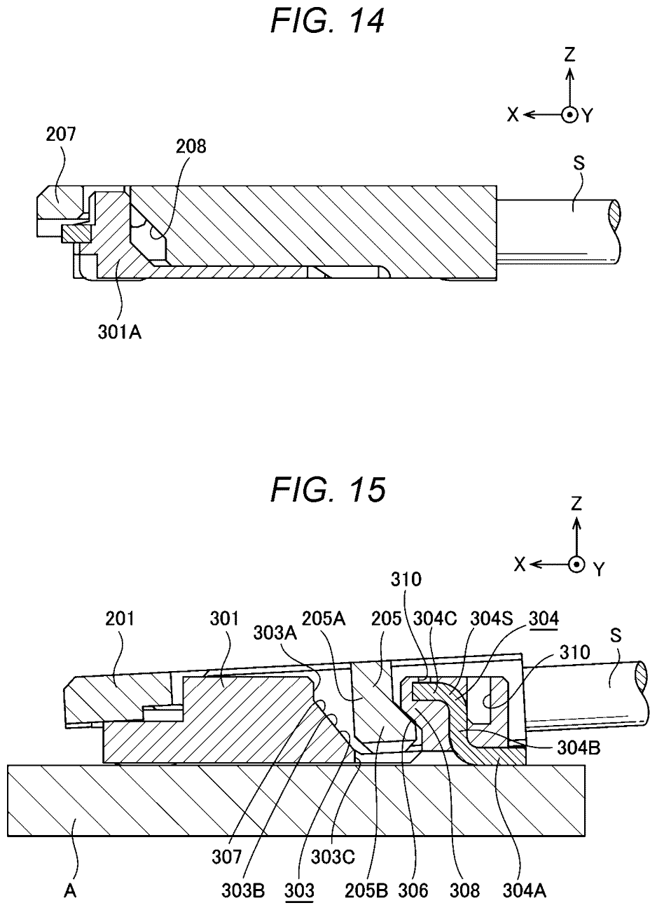

As shown in FIG. 14, when the cable connector 200 approaches the board connector 300 in the Z-axis direction, the upper surface of the first side wall portion 301A of the board connector 300 slides toward an end portion of the cable connector 200 in the X-axis direction on the guide portion 208 of the cable connector 200. Note that in the state after the cable connector 200 and the board connector 300 have been fitted in each other, the upper surface of the first side wall portion 301A of the board connector 300 and the guide portion 208 of the cable connector 200 closely contact each other with no gap therebetween. That is, in the state of the cable connector 200 and the board connector 300 being fitted in each other, the first side wall portion 301A of the board connector 300 positions the cable connector 200 and the board connector 300 in the Y-axis direction.

Next, the features of the connector device 100 of the present embodiment will be described focusing particularly on features when the cable S is pulled in the state of the cable connector 200 and the board connector 300 being fitted in each other.

FIG. 15 shows a state when the cable S is pulled in the Z-axis direction from the state of the cable connector 200 and the board connector 300 being fitted in each other. In this state, a gap between the protrusion 205 of the cable connector 200 and the engagement portion 306 of the board connector 300 functions as an extra space allowing relative movement of the cable connector 200 and the board connector 300, and the cable connector 200 tilts in the X-axis direction with the first side wall portion 301A of the board connector 300 as the point of support. The protrusion 205 of the cable connector 200 is engaged with the engagement portion 306 of the board connector 300 in a circumferential direction about the Y-axis with the first side wall portion 301A of the board connector 300 as the point of support, and is positioned in the Z-axis direction on the engagement portion 306 of the board connector 300. That is, the protrusion 205 is configured to be engageable with the engagement portion 306 in a circumferential direction centered on the Y-axis direction. When the cable S is pulled in the Z-axis direction from the state of the cable connector 200 and the board connector 300 being fitted in each other, the protrusion 205 of the cable connector 200 is engaged with the engagement portion 306 of the board connector 300 in a direction perpendicular to the Y-axis direction.

In the present embodiment, the first portion 304A of the reinforcing metal fitting 304 includes the portion S2 (see FIG. 10) overlapping with the protrusion 205 of the cable connector 200 in the Y-axis direction. In this case, the first portion 304A of the reinforcing metal fitting 304 mounted on the circuit board A suitably receives the stress applied from the protrusion 205 of the cable connector 200 at the portion S2 disposed at the position overlapping with the protrusion 205 in a direction crossing a direction (X-axis direction) of attaching the cable S. With this configuration, when the cable S is pulled, tilting of the posture of the cable connector 200 beyond a predetermined amount or more with respect to a direction of pulling the cable S is reduced, and a state of the cable connector 200 and the board connector 300 being stably fitted in each other is maintained. Thus, the resistance of the connector device 100 against force applied from the outside is enhanced.

In the present embodiment, the buffer portion 308 is interposed between the third portion 304C of the reinforcing metal fitting 304 and the engagement portion 306 of the board connector 300. The buffer portion 308 reduces transmission of the stress, which acts on the engagement portion 306 from the protrusion 205, to the reinforcing metal fitting 304 in a state of the protrusion 205 of the cable connector 200 being engaged with the engagement portion 306 of the board connector 300. Thus, the resistance of the connector device 100 against the force applied from the outside is further enhanced. Particularly, in the present embodiment, the third portion 304C of the reinforcing metal fitting 304 includes the portion S1 (see FIG. 7) overlapping with the engagement portion 306 of the board connector 300 in the X-axis direction. With this configuration, the third portion 304C of the reinforcing metal fitting 304 is easily positioned on the path on which the above-described stress acting on the engagement portion 306 from the protrusion 205 is transmitted, and therefore, transmission of such stress to the reinforcing metal fitting 304 is suitably reduced.

Note that the embodiments of the present disclosure are not independent of each other, but may be implemented in combination as necessary. For example, in the present embodiment, the example where the reinforcing metal fitting 304 is insert-molded into the housing 301 has been described, but instead, the reinforcing metal fitting 304 may be fixed to the housing 301 by press-fitting. The above-described embodiments are examples for describing the present disclosure, and the present disclosure is not limited to these embodiments. The present disclosure can be implemented in various forms without departing from the gist thereof.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A connector device comprising:
a first connector and a second connector fittable in each other,
wherein the first connector includes a first housing,
the first housing has an attachment portion and a protrusion,
the attachment portion is configured such that a cable is attachable thereto,
the protrusion protrudes outward in a second direction crossing a first direction which is a direction of attaching the cable to the attachment portion,
the second connector has a second housing,
the second housing has an engagement portion and a reinforcing metal fitting located on a tip end side in the first direction with respect to the engagement portion,
the engagement portion includes an inclined surface with a downward slope toward the reinforcing metal fitting, and is configured such that the protrusion is engageable therewith in a direction perpendicular to the second direction,
the reinforcing metal fitting has a mounting portion to be mounted on a circuit board, and
the mounting portion includes a portion overlapping with the protrusion in the second direction.

2. The connector device according to claim 1, wherein
the second housing has a buffer portion interposed between the engagement portion and the reinforcing metal fitting.

3. The connector device according to claim 2 wherein
the reinforcing metal fitting and the second housing are formed by insert molding.

4. The connector device according to claim 1, wherein
the reinforcing metal fitting includes a portion bent or curved in a raised shape in a direction orthogonal to the inclined surface of the engagement portion and a direction from the engagement portion toward the reinforcing metal fitting.

5. The connector device according to claim 1, wherein
the reinforcing metal fitting includes a portion overlapping with the engagement portion in the first direction.

6. The connector device according to claim 1, wherein
the protrusion includes a first portion and a second portion,
the first portion of the protrusion linearly extends in a third direction perpendicular to both the first direction and the second direction from an upper surface toward a lower surface of the first housing,
the second portion of the protrusion includes an inclined surface with a downward slope from a lower end of the first portion of the protrusion toward the attachment portion.

7. The connector device according to claim 1, wherein
a recess having an opening is provided on an upper surface of the second housing, and the reinforcing metal fitting is exposed through the opening.

8. The connector device according to claim 1, wherein
the protrusion is configured to be engageable with the engagement portion in a circumferential direction centered on the second direction.

9. The connector device according to claim 1, wherein
the second housing includes an insertion portion that penetrates the second housing in a third direction perpendicular to both the first direction and the second direction and is configured such that the protrusion is insertable thereinto,
the insertion portion is formed in a step and includes a first portion, a second portion, and a third portion,
the first portion of the insertion portion linearly extends in the third direction from an upper surface toward a lower surface of the second housing,
the second portion of the insertion portion extends linearly and diagonally with respect to the third direction from a lower end of the first portion toward the reinforcing metal fitting, and
the third portion of the insertion portion linearly extends in the third direction from a lower end of the second portion toward the lower surface of the second housing.
